(19) United States
(12) Patent Application Publication
(10) Pub. No.: US 2012/0145968 A1
(43) Pub. Date: Jun. 14, 2012

(54) PROCESS FOR PRODUCING TRANSPARENT CONDUCTIVE FILMS, TRANSPARENT CONDUCTIVE FILM, PROCESS FOR PRODUCING CONDUCTIVE FIBERS, CONDUCTIVE FIBER, CARBON NANOTUBE/CONDUCTIVE POLYMER COMPOSITE DISPERSION, PROCESS FOR PRODUCING CARBON NANOTUBE/CONDUCTIVE POLYMER COMPOSITE DISPERSIONS, AND ELECTRONIC DEVICE

(75) Inventor: Keisuke Shimizu, Kanagawa (JP)

(73) Assignee: SONY CORPORATION, Tokyo (JP)

(21) Appl. No.: 13/309,186

(22) Filed: Dec. 1, 2011

(30) Foreign Application Priority Data
Dec. 10, 2010 (JP) 2010-275800

(51) Int. Cl. H01B 1/12; B05D 1/36; B05D 3/06; B82Y 40/00; B82Y 99/00

(52) U.S. Cl. 252/511; 427/407.1; 427/553; 427/535; 977/742; 977/842

(57) ABSTRACT

A process for producing transparent conductive films includes mixing and dispersing a carbon nanotube having a hydrophilic group introduced on the surface thereof and a hydrophilic conductive polymer in a solvent to obtain a carbon nanotube/conductive polymer composite dispersion in which a weight ratio of the hydrophilic conductive polymer to the carbon nanotube is 0.5 or more and 4 or less, the concentration of the carbon nanotube being 0.1 g/L or more and 2.0 g/L or less, and attaching onto a transparent substrate the carbon nanotube/conductive polymer composite dispersion.

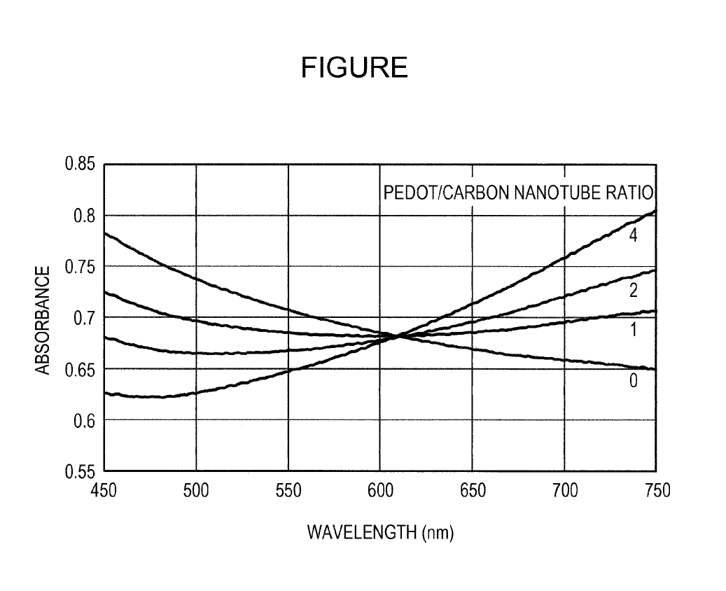

### BACKGROUND

The present disclosure relates to a process for producing transparent conductive films, a transparent conductive film, a process for producing conductive fibers, a conductive fiber, a carbon nanotube/conductive polymer composite dispersion, a process for producing carbon nanotube/conductive polymer composite dispersions, and an electronic device. For example, the present technology is suitably applied to transparent conductive films used in displays, touch panels, solar cells and the like, or conductive fibers used in conductive sheets and the like.

Indium-tin oxide (ITO) is a typical material of transparent conductive films. Because this material has poor mechanical properties and is susceptible to stress such as bending, ITO is not suitable for use in applications where flexibility is desired, such as displays or solar cells having a flexural plastic substrate. Further, ITO has another problem that indium exists in a limited amount and is therefore expensive. Furthermore, ITO film production involves vacuum processes such as sputtering, which increase facility costs and process costs. For these reasons, producing transparent conductive films by an application process using an ITO-alternative material has been studied.

Materials that have been studied as possible ITO-alternatives include conductive polymers and carbon nanotubes. A conductive polymer easily gives a dispersion and is thus suited for an application process. However, conductive polymers generally have low transparent conductive properties. PEDOT (polyethylene dioxythiophene) shows relatively high transparent conductive properties, but a conductive film fabricated therefrom takes on a blue color because this compound has a strong blue color.

Carbon nanotubes possess very high conductive properties, but dispersing them in a solvent is very difficult. Thus, a surfactant such as SDS (sodium dodecyl sulfate) is used as a dispersant to improve the dispersibility of carbon nanotubes. However, because SDS is nonconductive, the use of such a surfactant markedly lowers conductive properties of the resultant conductive film.

Thus, a technique for dispersing carbon nanotubes using a conductive polymer has been recently studied (see, for example, Japanese Patent No. 3913208). According to this technique, carbon nanotubes which show low dispersibility in a solvent are allowed to be suitably dispersed in the solvent by the use of a water-soluble conductive polymer as a conductive dispersant, and a conductive film is fabricated from the dispersion. However, this dispersion involves a large number of conductive polymer molecules relative to carbon nanotubes that are dispersed. Consequently, a conductive film fabricated using the dispersion reflects the color of the conductive polymer. In addition, it is difficult for the carbon nanotubes to form conductive paths. Thus, obtaining a transparent conductive film having high conductive properties is difficult. Further, although the conductive polymer improves the dispersibility of carbon nanotubes, it is difficult to produce the dispersion in high concentration. If the dispersion has a low concentration, the dispersion is repeatedly applied when low-resistivity conductive films are produced by, for example, printing. This is a great disadvantage in the process.

Further, carbon nanotube/conductive polymer dispersions have been studied (see, for example, Japanese Unexamined Patent Application Publication No. 2008-50391). Similarly to the above, these carbon nanotube/conductive polymer dispersions involve a large number of conductive polymer molecules relative to carbon nanotubes, and the carbon nanotube concentration in the dispersion is low. Accordingly, it is difficult to produce a high-concentration dispersion that is less colored or colorless and has high transparent conductive properties.

PEDOT mentioned above is the most promising conductive polymer that is widely used. The conductive properties of PEDOT may be markedly increased by adding several % by weight (wt %) of an additive such as NMP (n-methylpyrrolidone), ethylene glycol or DMSO (dimethylsulfoxide) to a PEDOT solution. However, PEDOT has rather poor affinity for carbon nanotubes and therefore the addition thereof to a carbon nanotube dispersion may result in a marked decrease of dispersing properties of the dispersion.

### SUMMARY

As described above, it has been difficult in the related art to produce a transparent conductive film that is less colored or colorless and has high transparent conductive properties by an application process.

It is desirable to provide a process for producing transparent conductive films, which can produce a transparent conductive film that is less colored or colorless and has high transparent conductive properties easily and at low cost using an application process.

It is also desirable to provide a transparent conductive film being less colored or colorless and having high transparent conductive properties that contains components including a carbon nanotube and a conductive polymer, and to provide an electronic device having the transparent conductive film.

It is further desirable to provide a carbon nanotube/conductive polymer composite dispersion which is suitably used in the production of transparent conductive films being less colored or colorless and having high transparent conductive properties that contain components including a carbon nanotube and a conductive polymer, and to provide a process for producing such a dispersion.

A process for producing transparent conductive films according to an embodiment of the present disclosure includes mixing and dispersing a carbon nanotube having a hydrophilic group introduced on the surface thereof and a hydrophilic conductive polymer in a solvent to obtain a carbon nanotube/conductive polymer composite dispersion in which a weight ratio of the hydrophilic conductive polymer to the carbon nanotube is 0.5 or more and 4 or less, the concentration of the carbon nanotube being 0.1 g/L or more and 2.0 g/L or less; and attaching onto a transparent substrate the carbon nanotube/conductive polymer composite dispersion.

A transparent conductive film according to an embodiment of the present disclosure is produced by a process that includes mixing and dispersing a carbon nanotube having a hydrophilic group introduced on the surface thereof and a hydrophilic conductive polymer in a solvent to obtain a carbon nanotube/conductive polymer composite dispersion in which a weight ratio of the hydrophilic conductive polymer to the carbon nanotube is 0.5 or more and 4 or less, the concentration of the carbon nanotube being 0.1 g/L or more and 2.0 g/L or less, and attaching onto a transparent substrate the carbon nanotube/conductive polymer composite dispersion.

A process for producing conductive fibers according to an embodiment of the present disclosure includes mixing and dispersing a carbon nanotube having a hydrophilic group introduced on the surface thereof and a hydrophilic conductive polymer in a solvent to obtain a carbon nanotube/conductive polymer composite dispersion in which a weight ratio of the hydrophilic conductive polymer to the carbon nanotube is 0.5 or more and 4 or less, the concentration of the carbon nanotube being 0.1 g/L or more and 2.0 g/L or less; and attaching onto the surface of a fiber the carbon nanotube/conductive polymer composite dispersion.

A conductive fiber according to an embodiment of the present disclosure is produced by a process that includes mixing and dispersing a carbon nanotube having a hydrophilic group introduced on the surface thereof and a hydrophilic conductive polymer in a solvent to obtain a carbon nanotube/conductive polymer composite dispersion in which a weight ratio of the hydrophilic conductive polymer to the carbon nanotube is 0.5 or more and 4 or less, the concentration of the carbon nanotube being 0.1 g/L or more and 2.0 g/L or less, and attaching onto the surface of a fiber the carbon nanotube/conductive polymer composite dispersion.

A carbon nanotube/conductive polymer composite dispersion according to an embodiment of the present disclosure is a dispersion in which a carbon nanotube having a hydrophilic group introduced on the surface thereof and a hydrophilic conductive polymer are mixed and dispersed in a solvent so that a weight ratio of the hydrophilic conductive polymer to the carbon nanotube is 0.5 or more and 4 or less, the concentration of the carbon nanotube being 0.1 g/L or more and 2.0 g/L or less.

A process for producing carbon nanotube/conductive polymer composite dispersions according to an embodiment of the present disclosure includes mixing a hydrophilic conductive polymer and a carbon nanotube having a hydrophilic group introduced on the surface thereof so that the weight ratio of the hydrophilic conductive polymer to the carbon nanotube is 0.5 or more and 4 or less, and dispersing the mixture in a solvent to a concentration of the carbon nanotube of 0.1 g/L or more and 2.0 g/L or less.

An electronic device according to an embodiment of the present disclosure has a transparent conductive film produced by a process that includes mixing and dispersing a carbon nanotube having a hydrophilic group introduced on the surface thereof and a hydrophilic conductive polymer in a solvent to obtain a carbon nanotube/conductive polymer composite dispersion in which a weight ratio of the hydrophilic conductive polymer to the carbon nanotube is 0.5 or more and 4 or less, the concentration of the carbon nanotube being 0.1 g/L or more and 2.0 g/L or less, and attaching onto a transparent substrate the carbon nanotube/conductive polymer composite dispersion.

The carbon nanotube, the hydrophilic conductive polymer and the solvent used in the present disclosure are not particularly limited and may be selected appropriately. The transparent substrate and the fiber are not particularly limited and may be selected appropriately. The fiber is typically a synthetic fiber.

A hydrophilic group may be introduced to the surface of the carbon nanotube by any methods without limitation. Typically, the surface of the carbon nanotube is treated with an acid to introduce a hydrophilic group. Any acids may be appropriately selected and used in the treatment as desired without limitation. Specific examples of the acids include hydrochloric acid, hydrogen peroxide water, nitric acid and sulfuric acid.

In the carbon nanotube/conductive polymer composite dispersion, the weight ratio of the hydrophilic conductive polymer to the carbon nanotube having a hydrophilic group introduced on the surface thereof is preferably in the range of 1 to 2 from the viewpoint of obtaining a transparent conductive film that is less colored or colorless. The carbon nanotube/conductive polymer composite dispersion preferably has a ratio of the absorbance at 750 nm wavelength light to the absorbance at 450 nm wavelength light of 0.8 or more and 1.2 or less.

Preferably, the surface of the transparent substrate is subjected to a hydrophilization treatment before the carbon nanotube/conductive polymer composite dispersion is attached onto the transparent substrate. In this manner, the adhesion of the transparent conductive film with respect to the transparent substrate is improved. Typically, the surface of the transparent substrate may be treated with UV rays (UV treatment) or with plasma to render the surface of the transparent substrate hydrophilic before the carbon nanotube/conductive polymer composite dispersion is attached onto the transparent substrate. Alternatively, a silane coupling agent or a hydrophilic conductive polymer may be applied to the surface of the transparent substrate to render the surface of the transparent substrate hydrophilic before the carbon nanotube/conductive polymer composite dispersion is attached onto the transparent substrate.

In order to prevent the reflection of light on the surface of the transparent conductive film or to protect the surface of the transparent conductive film, it is preferable to perform an antireflection treatment and/or a surface protection treatment on the outermost surface of the transparent conductive film.

In the case where an additive is used to improve the conductive properties of the conductive polymer, such an additive is preferably used by being applied as a separate solution of the additive and conductive polymer rather than being added to the carbon nanotube/conductive polymer composite dispersion. That is, after the carbon nanotube/conductive polymer composite dispersion is applied, a solution of the additive and conductive polymer is applied thereon. In this manner, the conductive properties of the conductive polymer in the final transparent conductive film can be improved without lowering the dispersibility of the carbon nanotube in the carbon nanotube/conductive polymer composite dispersion. Any appropriate additives may be selected without limitation in accordance with the conductive polymer to be used.

According to the transparent conductive film or the process for producing transparent conductive films, there may be obtained a transparent conductive film that has good transparent conductive properties with a sheet resistivity of 10Ω/□ to 10000Ω/□ and a total light transmittance of not less than 70%. Further, there may be obtained a transparent conductive film that has a difference of not more than 5% between the transmittance at 750 nm wavelength light and the transmittance at 450 nm wavelength light. That is, a transparent conductive film having a substantially constant transmittance at the visible light region may be obtained.

The transparent conductive film may be used as a transparent conductive film or a transparent conductive sheet.

The electronic devices may be various devices as long as they have the transparent conductive film. Specific examples include displays such as liquid crystal displays (LCD) and organic electroluminescence displays (organic EL displays) and touch panels. The purpose of use of the transparent conductive film in the devices is not particularly limited.

According to the embodiments of the present technology described above, the transparent conductive films show high conductive properties because a network is suitably formed among carbon nanotubes. Further, the hydrophilicity imparted to the carbon nanotubes allows the carbon nanotubes to be dispersed at a high concentration. Furthermore, because the carbon nanotubes form a network and show high hydrophilicity due to the hydrophilic group added on the surface thereof, the adhesion of the transparent conductive film with respect to the transparent substrate may be improved by, for example, increasing the hydrophilicity of the surface of the transparent substrate. Still further, the increase of the carbon nanotube concentration in the carbon nanotube/conductive polymer composite dispersion enables simplifying the application process. Furthermore, because the carbon nanotube/conductive polymer composite dispersion can be obtained in various concentrations, the dispersion may be used in a variety of printing processes. Further, the color intensity of the carbon nanotube/conductive polymer composite dispersion can be reduced by appropriately selecting the weight ratio of the conductive polymer relative to the carbon nanotube in the dispersion. The use of such a carbon nanotube/conductive polymer composite dispersion enables producing a transparent conductive film that is less colored or colorless. By separately applying an additive for the conductive polymer after the dispersion is applied, the conductive properties of the conductive polymer can be increased and the conductive properties of the final transparent conductive film can be improved without lowering the dispersibility of the carbon nanotube. Further, this carbon nanotube/conductive polymer composite dispersion having a high concentration realizes high adhesion with respect to the substrate and high conductivity. Thus, the dispersion can be applied to a wide range of objects including not only transparent substrates but fibers such as synthetic fibers, various fibrous materials, various uneven materials and elastic or stretchable transparent materials.

The carbon nanotube/conductive polymer composite dispersion according to the embodiments of the present disclosure can be suitably used in the production of transparent conductive films that are less colored or colorless and have high transparent conductive properties. Transparent conductive films that are less colored or colorless and have high transparent conductive properties can be easily produced at low cost by an application process using the carbon nanotube/conductive polymer composite dispersion. Further, high-performance electronic devices can be manufactured by using the transparent conductive film in the electronic devices. Furthermore, transparent conductive fibers that are less colored or colorless and have high transparent conductive properties can be easily produced at low cost by an application process using the carbon nanotube/conductive polymer composite dispersion.

### BRIEF DESCRIPTION OF THE DRAWING

FIGURE is a schematic diagram that shows results of measurement of the absorbance of carbon nanotube/conductive polymer composite dispersions having PEDOT/carbon nanotube ratios different from each other.

### DETAILED DESCRIPTION OF EMBODIMENTS

Embodiments for carrying out the present technology (hereinafter, referred to as “embodiments”) will be described hereinbelow in the order as follows:

1. First embodiment (carbon nanotube/conductive polymer composite dispersions, and processes for producing the same)

2. Second embodiment (transparent conductive films, and processes for producing the same)

3. Third embodiment (conductive fibers, and processes for producing the same)

### 1. First Embodiment

### Carbon Nanotube/Conductive Polymer Composite Dispersions, and Processes for Producing the Same

A carbon nanotube/conductive polymer composite dispersion according to the first embodiment of the present disclosure is obtained by mixing a hydrophilic conductive polymer with a carbon nanotube having a hydrophilic group introduced on the surface thereof in which the weight ratio of the hydrophilic conductive polymer to the carbon nanotube is 0.5 or more and 4 or less, and dispersing the mixture in a solvent to a concentration of the carbon nanotube of 0.1 g/L or more and 2.0 g/L or less.

The carbon nanotube may be a single-layer carbon nanotube or a multilayer carbon nanotube. The diameter and the length thereof are not particularly limited. The carbon nanotube may be basically obtained by any method. Specific examples of the synthetic methods include laser ablation methods, electric arc discharge methods and chemical vapor deposition (CVD) methods.

For example, the hydrophilic group that is added to the surface of the carbon nanotube may be the hydroxyl group (—OH), the carboxyl group (—COOH), the amino group (—NH₂) or the sulfonic acid group (—SO₃H). The number of the hydrophilic groups added to the surface of the carbon nanotube may be determined appropriately. To introduce the hydrophilic group to the surface of the carbon nanotube, the surface of the carbon nanotube is preferably treated with an acid such as hydrochloric acid, hydrogen peroxide water, nitric acid or sulfuric acid. In carrying out the treatment, the acid is preferably heated to a temperature higher than normal temperature. However, the treatment is not limited to such an embodiment, and the acid may be used at normal temperature. The heating temperature for the acid may be determined appropriately in accordance with the acid that is used. The treatment time may be determined appropriately in accordance with the acid to be used and the treatment temperature so that a desired number of the hydrophilic groups can be added to the surface of the carbon nanotube.

The hydrophilic (or water-soluble) conductive polymers are not particularly limited and may be selected appropriately (see, for example, Japanese Patent No. 3913208). Examples of the hydrophilic conductive polymers include polymers with a π-conjugated skeleton that contain repeating units such as phenylenevinylene, vinylene, thienylene, pyrrolylene, phenylene, iminophenylene, isothianaphthene, furylene or carbazolylene; and polymers corresponding to the above polymers except that the nitrogen atom in the π-conjugated polymer is bonded with an acidic group, an alkyl group substituted with an acidic group, or an alkyl group having an ether bond. Of the hydrophilic conductive polymers, those having the sulfonic acid group and/or the carboxyl group are preferably used from the viewpoints of solubility in solvents, conductive properties and film-forming properties. The hydrophilic conductive polymer shows very high solubility in solvents such as water and water-containing organic solvents when the content (the number) of the repeating units having the sulfonic acid group and/or the carboxyl group is not less than 50% of the number of all the repeating units in the polymer. Thus, such a polymer is preferably used in the present technology. The content of the repeating units having the sulfonic acid group and/or the carboxyl group is more preferably not less than 70%, still more preferably not less than 90%, and most preferably 100%.

The solvents for dispersing a carbon nanotube and a conductive polymer are not particularly limited as long as the carbon nanotube and the conductive polymer can be dispersed therein. Basically, any solvents may be used. Specific examples of the solvents include water, alcohols, ketones, ethylene glycols, propylene glycols, amides, pyrrolidones, hydroxy esters and anilines. Examples of the alcohols include methanol, ethanol, isopropyl alcohol, propyl alcohol and butanol. Examples of the ketones include acetone, methyl ethyl ketone, ethyl isobutyl ketone and methyl isobutyl ketone. Examples of the ethylene glycols include ethylene glycol, ethylene glycol methyl ether and ethylene glycol mono-n-propyl ether. Examples of the propylene glycols include propylene glycol, propylene glycol methyl ether, propylene glycol ethyl ether, propylene glycol butyl ether and propylene glycol propyl ether. Examples of the amides include dimethylformamide and dimethylacetamide. Examples of the pyrrolidones include N-methylpyrrolidone and N-ethylpyrrolidone. Examples of the hydroxy esters include dimethylsulfoxide, γ-butyrolactone, methyl lactate, ethyl lactate, methyl β-methoxyisobutyrate and methyl α-hydroxyisobutyrate. Examples of the anilines include aniline and N-methylaniline.

### Examples 1 to 10

Meijo-Arc manufactured by Meijo Nano Carbon Co., Ltd. was used as the carbon nanotube. The carbon nanotube was heated and purified in hydrogen peroxide water at 100° C. for 12 hours. By this treatment, the dispersibility of the carbon nanotube in water was improved. Accordingly, it was found that the treatment improved the hydrophilicity of the carbon nanotube as well as removed impurities. The improvement of hydrophilicity was ascribed to the addition of —OH groups onto the surface of the carbon nanotube. As comparative examples, dispersions of unpurified carbon nanotubes were prepared.

PEDOT/PSS (Baytron P manufactured by H. C. Stark GmbH, solid content 1.2 wt %) was used as the conductive polymer.

The carbon nanotube and the PEDOT solution were added to water. The mixture was ultrasonically treated for 10 minutes using a homogenizer. Thereafter, ethanol was added, and the mixture was further treated with a homogenizer for 20 minutes, thereby completely dispersing the carbon nanotube in the solution. In this manner, a carbon nanotube/conductive polymer composite dispersion was prepared. The dispersibility of the carbon nanotube was examined by changing the compositions and the components of the carbon nanotube/conductive polymer composite dispersions, the results being shown in Table 1. In Comparative Examples 1 to 3 and Examples 1 to 10, the carbon nanotube/conductive polymer composite dispersions contained the purified carbon nanotube. The carbon nanotube/conductive polymer composite dispersions in Comparative Examples 4 and 5 contained the unpurified carbon nanotube. The water:ethanol ratio in each of the dispersions was adjusted in the range of 1:10 to 1:3. The application was more difficult as the proportion of water in the dispersion increased. However, the dispersibility was higher with increasing proportion of water.

TABLE 1

| | | | PEDOT/ | |
|---|---|---|---|---|
| | Carbon nanotube | PEDOT | carbon | |
| | concentration | concentration | nanotube | |
| | (g/L) | (g/L) | ratio | Dispersibility |
| Ex. 1 | 0.1 | 0.1 | 1 | ◯ |
| Ex. 2 | 0.2 | 0.2 | 1 | ◯ |
| Ex. 3 | 0.4 | 0.2 | 0.5 | ◯ |
| Ex. 4 | 0.4 | 0.8 | 2 | ◯ |
| Ex. 5 | 0.6 | 2.4 | 4 | ◯ |
| Ex. 6 | 0.6 | 1.2 | 2 | ◯ |
| Ex. 7 | 0.6 | 0.6 | 1 | ◯ |
| Ex. 8 | 0.8 | 0.8 | 1 | ◯ |
| Ex. 9 | 1.0 | 1.0 | 1 | ◯ |
| Ex. 10 | 2.0 | 2.0 | 1 | ◯ |
| Comp. | 0.1 | 0 | 0 | ◯ |
| Ex. 1 | | | | |
| Comp. | 0.2 | 0 | 0 | X |
| Ex. 2 | | | | (partially |
| | | | | precipitated) |
| Comp. | 1.0 | 1.0 | 1.0 | X |
| Ex. 3 | | | | (partially |
| | | | | precipitated) |
| Comp. | 0.1 | 0 | 0 | X |
| Ex. 4 | | | | (partially |
| | | | | precipitated) |
| Comp. | 0.4 | 0.8 | 2 | X |
| Ex. 5 | | | | (aggregated) |

As shown in Table 1, the use of the purified carbon nanotube (Comparative Examples 1 to 3, and Examples 1 to 10) resulted in that the carbon nanotube alone generally showed low dispersibility but was allowed to be dispersed in the solution by the addition of PEDOT (Examples 1 to 10). On the other hand, the unpurified carbon nanotube (Comparative Examples 4 and 5) was not substantially dispersed even when PEDOT was added (Comparative Example 5). In Examples 1 to 10, the carbon nanotube concentration and the ratio of PEDOT to the carbon nanotube (PEDOT/carbon nanotube ratio) were changed. The results showed that the dispersions having a PEDOT/carbon nanotube ratio of 0.5 or more and 4 or less and a carbon nanotube concentration of 0.1 g/L or more and 2.0 g/L or less achieved high dispersibility of the carbon nanotube.

Of the dispersions in which the carbon nanotube was suitably dispersed, the dispersions in Comparative Example 1 and Examples 5 to 7 were measured for absorbance with a spectrophotometer. Before the measurement, the dispersion was diluted approximately 2 to 10 times with ethanol so that light would be transmitted through the dispersion appropriately. The results are described in FIGURE. For easy comparison, the absorbance curves in FIGURE have been standardized such that the total of absorbance in the region from 450 nm to 750 nm would be equal to one another among the absorbance curves. At the high PEDOT/carbon nanotube ratio, the absorbance on the long wavelength side was high because of the influence of the absorption of light by PEDOT. The absorbance curve became more flat with decreasing PEDOT/carbon nanotube ratio. On the other hand, the absorbance on the short wavelength side was somewhat higher when the dispersion contained the carbon nanotube alone as in Comparative Example 1. When the PEDOT/carbon nanotube ratio was in the range of 1 to 2 in Examples 6 and 7, the development of color in the visible light region was suppressed to a low level. There was substantially no color development in the visible light region when the PEDOT/carbon nanotube ratio was approximately 1. These results indicate that the development of color of the dispersion can be controlled by appropriately adjusting the PEDOT/carbon nanotube ratio.

According to the first embodiment demonstrated above, there can be obtained the carbon nanotube/conductive polymer composite dispersion that is less colored or colorless, has high transparent conductive properties and high carbon nanotube concentration and is highly suited for a printing process.

### 2. Second Embodiment

### Transparent Conductive Films, and Processes for Producing the Same

In a process for producing transparent conductive films according to the second embodiment, a transparent conductive film is produced by a printing process using the carbon nanotube/conductive polymer composite dispersion according to the first embodiment.

In detail, a transparent conductive film is produced by printing the carbon nanotube/conductive polymer composite dispersion on a transparent substrate by a printing process. In the carbon nanotube/conductive polymer composite dispersion, a mixture that includes the carbon nanotube having a hydrophilic group introduced on the surface thereof and the hydrophilic conductive polymer in the solvent in which a weight ratio of the hydrophilic conductive polymer to the carbon nanotube is 0.5 or more and 4 or less, the concentration of the carbon nanotube being 0.1 g/L or more and 2.0 g/L or less.

Various transparent substrates may be used in the present embodiment, and an appropriate transparent substrate may be selected accordingly. Specific examples of the transparent substrates include glass substrates, quartz substrates and flexible substrates such as transparent plastic substrates. Examples of the transparent plastic substrates include but are not limited to polyethylene terephthalate (PET), polyethylene, polypropylene, polystyrene and polycarbonate substrates. The printing methods are not particularly limited. Exemplary printing methods include gravure printing, flexographic printing, lithographic printing, relief printing, offset printing, intaglio printing, rubber plate printing and screen printing.

According to the process, a transparent conductive film formed of the carbon nanotube and the conducive polymer is produced on the transparent substrate. The transparent conductive film contains the conductive polymer a weight ratio of which to the carbon nanotube is 0.5 or more and 4 or less.

### Examples 11 to 18

The carbon nanotube/conductive polymer composite dispersions prepared in Examples 1-3, 5-7, 9 and 10 were each applied onto a PET substrate (LUMIRROR U34 manufactured by TORAY INDUSTRIES, INC., thickness: 100 μm, total light transmittance: 92%) with a bar coater (gap: 100 μm), thereby preparing transparent conductive films (Examples 11 to 18). The application was carried out on a hot plate at 60° C. After the dispersion was applied, a PEDOT solution in which DMSO as an additive had been diluted 10 times with isopropyl alcohol was applied in the same manner to increase the conductive properties of PEDOT.

It is typical practice to add an additive such as DMSO to a dispersion before the dispersion is applied. However, as was expected, the dispersibility of the carbon nanotube was markedly decreased when DMSO was added directly to the carbon nanotube/conductive polymer composite dispersion. Thus, DMSO was applied afterward as described above to solve this problem.

The results of measurement of the properties of the transparent conductive films are described in Table 2. As shown in Table 2, the sheet resistivity was reduced as the PEDOT/carbon nanotube ratio was decreased. Further, the difference between the transmittance at 750 nm wavelength and that at 450 nm wavelength became smaller with decreasing PEDOT/carbon nanotube ratio, and the transparent conductive films were less colored or colorless.

TABLE 2

| | | | | | Difference |
|---|---|---|---|---|---|
| | PEDOT/ | | | | between |
| | carbon | Sheet | Trans- | Trans- | transmittance |
| | nanotube | resistivity | mittance | mittance | at 750 nm and |
| | ratio | (Ω/□) | (750 nm) | (450 nm) | that at 450 nm |
| Ex. 11 | 1 | 180 | 83% | 83% | 0% |
| Ex. 12 | 1 | 180 | 83% | 83% | 0% |
| Ex. 13 | 0.5 | 250 | 84% | 83% | 1% |
| Ex. 14 | 4 | 350 | 81% | 85% | 4% |
| Ex. 15 | 2 | 300 | 81% | 83% | 2% |
| Ex. 16 | 1 | 200 | 83% | 83% | 0% |
| Ex. 17 | 1 | 220 | 82% | 82% | 0% |
| Ex. 18 | 1 | 200 | 80% | 80% | 0% |

According to the second embodiment described above, the transparent conductive films that are less colored or colorless and have high transparent conductive properties can be easily obtained at low cost by applying the carbon nanotube/conductive polymer composite dispersion in the first embodiment onto the transparent substrate. The transparent conductive films may be used in various electronic devices or electronic elements. The electronic devices or electronic elements include generally all kinds of electronic devices or electronic elements that can use the transparent conductive films irrespective of usage applications or functions. Specific examples include but are not limited to touch panels, displays, solar cells, photoelectric conversion elements, field-effect transistors (FET), thin-film transistors (TFT) and molecular sensors.

### 3. Third Embodiment

### Conductive Fibers, and Processes for Producing the Same

In a process for producing conductive fibers according to the third embodiment, a conductive fiber is produced by a printing process using the carbon nanotube/conductive polymer composite dispersion according to the first embodiment.

In detail, a conductive fiber is produced by forming a transparent conductive film on the surface of a fiber by a method such as a dipping method using the carbon nanotube/conductive polymer composite dispersion in which a mixture that includes the carbon nanotube having a hydrophilic group introduced on the surface thereof and the hydrophilic conductive polymer is dispersed in the solvent in which a weight ratio of the hydrophilic conductive polymer to the carbon nanotube is 0.5 or more and 4 or less, the concentration of the carbon nanotube being 0.1 g/L or more and 2.0 g/L or less. The fiber on which the transparent conductive film is formed may be a transparent fiber or a nontransparent fiber. A transparent fiber gives a transparent conductive fiber, and a nontransparent fiber gives a nontransparent conductive fiber.

The transparent conductive film may be formed on various kinds of fibers without limitation, and an appropriate fiber may be selected accordingly. Synthetic fiber is typically used as the fiber. But the fibers used in the present disclosure are not limited to synthetic fibers. Examples of the synthetic fibers include acrylic fibers, acetate fibers and fibers formed of, for example, polyester, polyethylene, polyethylene terephthalate and polypropylene.

According to the process, a transparent conductive film formed of the carbon nanotube and the conducive polymer is produced on the surface of the transparent or nontransparent fiber, and thereby a transparent or nontransparent conductive fiber is manufactured. The transparent conductive film contains the conductive polymer a weight ratio of which to the carbon nanotube is 0.5 or more and 4 or less.

According to the third embodiment described above, the transparent or nontransparent conductive fibers can be easily obtained at low cost by applying the carbon nanotube/conductive polymer composite dispersion in the first embodiment onto the fibers. In particular, the use of the transparent fibers results in the transparent conductive fibers that are less colored or colorless and have high transparent conductive properties. The conductive fibers may be used in various applications, for example in the production of transparent or nontransparent conductive sheets.

Some of the embodiments and examples according to the present disclosure are described hereinabove. However, the present technology is not limited to the aforementioned embodiments and examples, and various modifications may occur insofar as they are within the scope of the appended claims or the equivalents thereof.

For example, the numerical values, structures, configurations, shapes and materials described in the aforementioned embodiments and examples are only exemplary and may be appropriately modified.

The present disclosure contains subject matter related to that disclosed in Japanese Priority Patent Application JP 2010-275800 filed in the Japan Patent Office on Dec. 10, 2010, the entire contents of which are hereby incorporated by reference.

What is claimed is:

1. A process for producing transparent conductive films, comprising:
mixing and dispersing a carbon nanotube having a hydrophilic group introduced on the surface thereof and a hydrophilic conductive polymer in a solvent to obtain a carbon nanotube/conductive polymer composite dispersion in which a weight ratio of the hydrophilic conductive polymer to the carbon nanotube is 0.5 or more and 4 or less, the concentration of the carbon nanotube being 0.1 g/L or more and 2.0 g/L or less; and
attaching onto a transparent substrate the carbon nanotube/conductive polymer composite dispersion.

2. The process for producing transparent conductive films according to claim 1, wherein the weight ratio of the hydrophilic conductive polymer to the carbon nanotube is 1 or more and 2 or less.

3. The process for producing transparent conductive films according to claim 2, wherein the hydrophilic group is introduced by treating the surface of the carbon nanotube with an acid.

4. The process for producing transparent conductive films according to claim 3, wherein the acid is hydrochloric acid, hydrogen peroxide water, nitric acid or sulfuric acid.

5. The process for producing transparent conductive films according to claim 4, wherein a ratio of the absorbance at 750 nm wavelength light of the carbon nanotube/conductive polymer composite dispersion to the absorbance at 450 nm wavelength light thereof is 0.8 or more and 1.2 or less.

6. The process for producing transparent conductive films according to claim 5, wherein the surface of the transparent substrate is subjected to a hydrophilization treatment before the carbon nanotube/conductive polymer composite dispersion is attached onto the transparent substrate.

7. The process for producing transparent conductive films according to claim 6, wherein the surface of the transparent substrate is treated with UV rays or plasma to render the surface of the transparent substrate hydrophilic before the carbon nanotube/conductive polymer composite dispersion is attached onto the transparent substrate.

8. The process for producing transparent conductive films according to claim 6, wherein a silane coupling agent or a hydrophilic conductive polymer is applied to the surface of the transparent substrate to render the surface of the transparent substrate hydrophilic before the carbon nanotube/conductive polymer composite dispersion is attached onto the transparent substrate.

9. The process for producing transparent conductive films according to claim 6, wherein an antireflection treatment and/or a surface protection treatment is performed on the outermost surface of the transparent conductive film.

10. The process for producing transparent conductive films according to claim 6, wherein the transparent conductive film has a sheet resistivity of 10Ω/□ to 10000Ω/□ and a total light transmittance of not less than 70%.

11. The process for producing transparent conductive films according to claim 6, wherein the transparent conductive film has a difference of not more than 5% between the transmittance at 750 nm wavelength light and the transmittance at 450 nm wavelength light.

12. A transparent conductive film produced by a process that comprises mixing and dispersing a carbon nanotube having a hydrophilic group introduced on the surface thereof and a hydrophilic conductive polymer in a solvent to obtain a carbon nanotube/conductive polymer composite dispersion in which a weight ratio of the hydrophilic conductive polymer to the carbon nanotube is 0.5 or more and 4 or less, the concentration of the carbon nanotube being 0.1 g/L or more and 2.0 g/L or less, and attaching onto a transparent substrate the carbon nanotube/conductive polymer composite dispersion.

13. The transparent conductive film according to claim 12, wherein the weight ratio of the hydrophilic conductive polymer to the carbon nanotube is 1 or more and 2 or less.

14. A process for producing conductive fibers, comprising:
mixing and dispersing a carbon nanotube having a hydrophilic group introduced on the surface thereof and a hydrophilic conductive polymer in a solvent to obtain a carbon nanotube/conductive polymer composite dispersion in which a weight ratio of the hydrophilic conductive polymer to the carbon nanotube is 0.5 or more and 4 or less, the concentration of the carbon nanotube being 0.1 g/L or more and 2.0 g/L or less; and
attaching onto the surface of a fiber the carbon nanotube/conductive polymer composite dispersion.

15. The process for producing conductive fibers according to claim 14, wherein the weight ratio of the hydrophilic conductive polymer to the carbon nanotube is 1 or more and 2 or less.

16. A conductive fiber produced by a process that comprises mixing and dispersing a carbon nanotube having a hydrophilic group introduced on the surface thereof and a hydrophilic conductive polymer in a solvent to obtain a carbon nanotube/conductive polymer composite dispersion in which a weight ratio of the hydrophilic conductive polymer to the carbon nanotube is 0.5 or more and 4 or less, the concentration of the carbon nanotube being 0.1 g/L or more and 2.0 g/L or less, and attaching onto the surface of a fiber the carbon nanotube/conductive polymer composite dispersion.

17. The conductive fiber according to claim 16, wherein the weight ratio of the hydrophilic conductive polymer to the carbon nanotube is 1 or more and 2 or less.

18. A carbon nanotube/conductive polymer composite dispersion wherein a carbon nanotube having a hydrophilic group introduced on the surface thereof and a hydrophilic conductive polymer are mixed and dispersed in a solvent so that a weight ratio of the hydrophilic conductive polymer to the carbon nanotube is 0.5 or more and 4 or less, the concentration of the carbon nanotube being 0.1 g/L or more and 2.0 g/L or less.

19. A process for producing carbon nanotube/conductive polymer composite dispersions, comprising:
mixing a hydrophilic conductive polymer and a carbon nanotube having a hydrophilic group introduced on the surface thereof so that the weight ratio of the hydrophilic conductive polymer to the carbon nanotube is 0.5 or more and 4 or less, and
dispersing the mixture in a solvent to a concentration of the carbon nanotube of 0.1 g/L or more and 2.0 g/L or less.

20. An electronic device including a transparent conductive film produced by a process that comprises mixing and dispersing a carbon nanotube having a hydrophilic group introduced on the surface thereof and a hydrophilic conductive polymer in a solvent to obtain a carbon nanotube/conductive polymer composite dispersion in which a weight ratio of the hydrophilic conductive polymer to the carbon nanotube is 0.5 or more and 4 or less, the concentration of the carbon nanotube being 0.1 g/L or more and 2.0 g/L or less, and attaching onto a transparent substrate the carbon nanotube/conductive polymer composite dispersion.
